(19) United States
(12) Patent Application Publication
(10) Pub. No.: US 2025/0380787 A1
(43) Pub. Date: Dec. 18, 2025

(54) Pet Nail Polisher

(71) Applicant: Shenzhen Nalanqing Electronic Commerce Co., Ltd., Shenzhen (CN)

(72) Inventor: Qiong CHEN, Shenzhen (CN)

(21) Appl. No.: 18/753,016

(22) Filed: Jun. 25, 2024

(30) Foreign Application Priority Data
Jun. 12, 2024 (CN) 202421328803.5

(51) Int. Cl. A45D 29/14; A01K 13/00

(52) U.S. Cl. CPC A45D 29/14; A01K 13/00

(57) ABSTRACT

The present disclosure discloses a pet nail polisher, includes: a main body, an end portion of the main body is provided with a polishing head; wherein carborundum is attached outside the polishing head; and the main body includes a surface housing and a bottom housing, and the top of the surface housing and the bottom housing is provided with a detachable mounting head. A user may replace the mounting head with a nail polisher head, a hair trimmer head, a vacuum cleaner head, a vacuum brush head, a hair dryer head, or a dog brush head according to needs. The present disclosure sprays the carborundum on the outside of the polishing head, to improve the hardness of the polishing head, accelerate the speed of nail polishing, increase the service life of the polishing head, reduce the frequency of changing the polishing head, the usage cost of the user is saved.

### CROSS-REFERENCE TO RELATED APPLICATIONS

This application claims priority to Chinese Patent Application No. 2024213288035, filed on Jun. 12, 2024, which is incorporated herein by reference in its entirety.

### TECHNICAL FIELD

The present disclosure relates to the technical field of nail polishers, in particular to a pet nail polisher thereof.

### BACKGROUND

Since nails of pets are all very sharp, pet nails can grow continuously during the feeding process. If it is not trimmed in time, it is easy to be scratched by the nails. Therefore, the pets require regular nails trimming, so that the nails are kept in an appropriate length that is not easy to scratch. When the pet nails are trimmed, nail clippers special for the pets are needed. However, the nail clippers for manual trimming are not easy to control the trimming length and easily cut the pets. At present, nail polishers are generally used on the market to polish and trim the nails. Corundum sand (such as chromium corundum sand, manganese corundum sand, and brown corundum sand) or quartz sand is attached outside a polishing head of the existing nail polisher, the hardness, nail polishing speed, and durability are all far inferior to those of a polishing head sprayed with carborundum, the service life is short, and the cost is high.

### SUMMARY

The purpose of the present disclosure is to provide a pet nail polisher, as to solve the problems proposed in the background.

In order to achieve the above purpose, the present disclosure provides the following technical schemes:
a pet nail polisher, comprising:
a main body, wherein an end portion of the main body is provided with a polishing head;
wherein carborundum is attached outside the polishing head; and
the particle size of the carborundum is 60˜150 mesh size, the thickness of the carborundum is 0.4˜0.6 mm, and the uniformity of the thickness is less than or equal to 0.1 mm.

Furthermore, the steps for attaching carborundum outside the polishing head are as follows:
(1) immersing the aluminum alloy polishing head to be sprayed completely in a degreaser, and immersing it in a degreaser at 30˜40° C. for 3˜4 minutes. The degreaser includes the following mass fraction components: 30˜40 parts of 75 wt % sulfuric acid, 2˜7 parts of citric acid, 4˜9 parts of ammonium hydrogen difluoride, 2˜4 parts of sodium edetate, 0.5˜1.5 parts of oxalic acid, 1˜2 parts of trichloroethylene, and 0.2˜0.5 parts of surfactant; among them, the surfactant is a combination of benzyldimethylstearylammonium chloride (CAS: 122-19-0), hexadecyltrimethylammonium chloride (CAS: 112-02-7), and fatty alcohol polyoxyethylene ether (AEO-9) with a weight ratio of 1.3˜1.6:1:0.4˜0.8;
(2) rinsing the degreased aluminum alloy polishing head to be sprayed with deionized water for 3˜5 minutes, then drying at 160˜180° C. for 10˜20 minutes to obtain a pretreated polishing head;
(3) using carborundum for spraying, pure nitrogen gas is used as the plasma gas during the spraying process. The plasma gas flow rate is 5000˜5500 L/h, the plasma pressure is 4˜5 MPa, the adjustment current is 750˜800 A, the control arc temperature is 4800˜5000° C., the powder feeding amount is 0.3˜0.5 g/min, and the spray gun movement speed is 40˜50 mm/min; after the spraying is completed, surface heat treatment is carried out, with insulation at 400˜600° C. for 15˜20 hours to obtain a sandblasted polishing head; and
(4) using a negative ion dust removal device to remove dust from the surface of the sandblasted polishing head.

Furthermore, diamond micro powder, nano alumina, silicon carbide, and boron nitride are added to the carborundum to obtain a mixed powder material, which is sprayed. Specifically, the mixed powder material includes the following mass fraction components: 80˜85 parts of the carborundum with the particle size D50 of 20 μm, 3˜5 parts of diamond micro powder, 1˜3 parts of nano alumina, 3˜6 parts of silicon carbide, and 2˜4 parts of boron nitride; spraying the pretreated polishing head with a mixed powder at 80˜85° C.

Diamond micro powder is the model W0.5 diamond micro powder produced by Zhongyuan Superhard Abrasive Tools Co., Ltd. in Zhecheng County; the particle diameter of nano alumina is 30˜60 nm, with a specific surface area of 10˜20 m²/g (Zhejiang Zhiti Nano Micro New Materials Co., Ltd.), and the average particle diameter of silicon carbide is 800 nm, with an average specific surface area of 20 m²/g (Jinlei Technology); the particle size of boron nitride is 2˜20 μm, with a specific surface area of 6˜25 m²/g (Shandong Jonye Advanced Materials Co., Ltd.).

During the processing, storage, and transportation of aluminum alloys, their surfaces are often contaminated with various oil stains and impurities such as processing oil, lubricating oil, rust proof oil, and fingerprint grease, which can hinder the attachment of carborundum. In order to improve the attachment between the surface of aluminum alloy polishing heads and carborundum, it is necessary to degrease the aluminum alloy polishing heads. The degreasing agents used in the prior art have incomplete degreasing, which may cause defects such as bubbles, detachment, and pinholes in the frosted layer, or excessive degreasing can lead to corrosion of the aluminum alloy surface, affecting subsequent processing and product durability. The degreasing agent of the present disclosure is compounded with multiple components, and the degreasing temperature and time are reasonably controlled to obtain a pretreated polishing head with good degreasing effect and improved attachment with carborundum. Especially when a specific proportion of surfactant is added to the degreaser, the wear resistance of the carborundum on the surface of the polishing head is improved. Analysis shows that a specific proportion of surfactants improves the surface tension of the degreaser, enhances its wetting ability on the surface of aluminum alloys, and allows the degreaser to penetrate deeper into small gaps and depressions, effectively removing pollutants from difficult to reach areas. This provides a more uniform and flat foundation for the subsequent spraying process of carborundum, provides more anchoring points for the coating, enhances the bonding strength between the coating and the substrate, and improves the durability of wear-resistant coatings.

The inventor found that although using only carborundum improved the hardness and wear resistance of the polishing head, the smoothness of the carborundum coating was not ideal, which affected the nail polishing effect. The present disclosure improves the smoothness of the coating of the nail polisher by selecting a specific particle size of carborundum and compounding it with various other components to produce a mixture for spraying. Analyzing components with different particle sizes for compounding has good dispersibility and crystal particle refinement effects, which can make the coating surface more delicate and smooth, significantly improve the smoothness of the coating, and improve the integrity of spraying. The inventor found that the corrosion resistance of the polishing head was improved under these conditions. Analysis is to form a denser protective layer, thereby improving the corrosion resistance of the coating.

Furthermore, the main body includes a surface housing and a bottom housing, the top of the surface housing and the bottom housing is provided with a detachable mounting head, and the mounting head is one of a nail polisher head, a hair trimmer head, a vacuum cleaner head, a vacuum brush head, a hair dryer head, or a dog brush head.

Furthermore, the mounting head is provided with a detachable end cover, clamping slots are mounted on both sides of the mounting head, clamping buckles are mounted on inner walls of both sides of the end cover, and the clamping buckles are adapted to the clamping slots.

Furthermore, the main body includes a surface housing and a bottom housing, and the top of the surface housing and the bottom housing are provided with an integrally formed mounting head.

Furthermore, the main body includes a surface housing and a bottom housing, the surface housing and the bottom housing are connected, a battery and a motor are mounted between the surface housing and the bottom housing, the motor is electrically connected with the battery, and the polishing head is fixedly mounted on an output end of the motor.

Furthermore, a grinding wheel sleeve is detachably sleeved outside the polishing head, and the polishing head and the grinding wheel sleeve are arranged in the end cover.

Furthermore, the top of the polishing head is provided with a dust collection hood, and the dust collection hood may replace the grinding wheel sleeve.

Furthermore, a connecting piece is fixedly mounted at the top of the mounting head, a clamping block is mounted on one side of the connecting piece, the dust collection hood is clamped on the connecting piece, and an inner wall of the dust collection hood is adapted to the clamping block.

Furthermore, an anti-skid plate is mounted on the surface of the surface housing and/or the bottom housing.

Furthermore, a speed controller is mounted on the surface of the surface housing and/or the bottom housing, the speed controller is electrically connected with the motor, and the speed controller is used to adjust the rotating speed of the motor.

Furthermore, a switch button is mounted on the surface of the surface housing and/or the bottom housing, and one side of the switch button extends to the outside of the surface housing and/or the bottom housing.

Furthermore, a side wall of the battery is provided with a printed circuit board (PCB) motherboard.

Furthermore, clamping slots are mounted on both sides of the mounting head, clamping buckles are mounted on inner walls of both sides of the end cover, and the clamping buckles are adapted to the clamping slots.

Compared with the prior art, the beneficial effects of the present disclosure are as follows: by processes such as adhesive, sandblasting, and pressure casting, the carborundum is attached outside the polishing head, the hardness of the polishing head is improved, thereby the speed of nail grinding is accelerated; and the service life of the polishing head is increased, and the frequency of changing the polishing head is reduced, thereby the usage cost of the user is saved. Its structure is simple, and each component is assembled in snap fastening, which is convenient to use and disassemble as a whole.

### BRIEF DESCRIPTION OF THE DRAWINGS

FIG. 1 is a schematic diagram of an exploded structure of the present disclosure;

FIG. 2 is a schematic diagram of a front view structure of the present disclosure;

FIG. 3 is a schematic diagram of a side view structure of the present disclosure;

FIG. 4 is a mounting schematic diagram of a mounting head of the present disclosure; and

FIG. 5 is a schematic diagram of carborundum attached to the polishing head of the present disclosure.

### DETAILED DESCRIPTION OF THE EMBODIMENTS

Technical schemes in embodiments of the present disclosure are clearly and completely described below in combination with drawings in the embodiments of the present disclosure. Apparently, the embodiments described are only a part of the embodiments of the present disclosure, not all of the embodiments. Based on the embodiments in the present disclosure, all other embodiments obtained by those of ordinary skill in the art without creative labor shall fall within the scope of protection of the present disclosure.

### Embodiment I

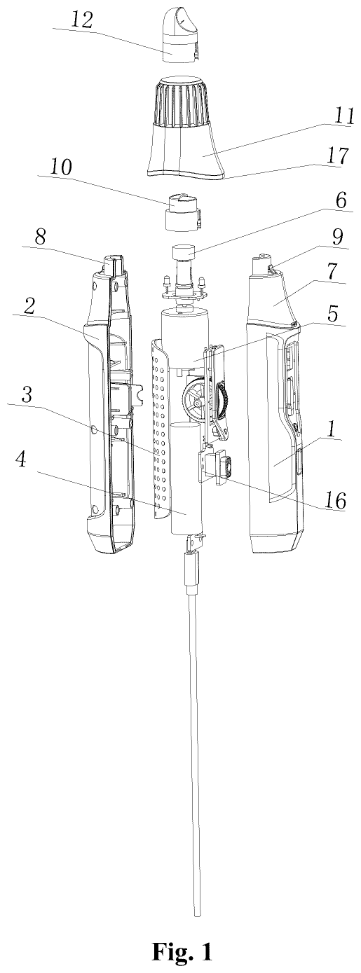

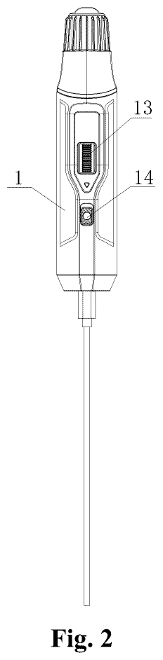

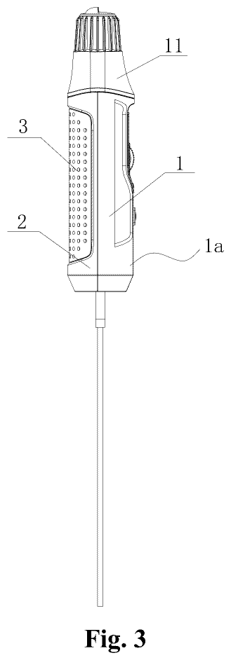

Please refer to FIGS. 1-3 and 5, the present disclosure provides a technical scheme: a pet nail polisher includes a main body 1a, and an end portion of the main body 1a is provided with a polishing head 6; and the particle size of the carborundum is 100 mesh size, the thickness of the carborundum is 0.5 mm, and the uniformity of the thickness is less than or equal to 0.1 mm.
(1) immersing the aluminum alloy polishing head to be sprayed completely in a degreaser, and immersing it in a degreaser at 35° C. for 3 minutes. The degreaser includes the following mass fraction components: 36 parts of 75 wt % sulfuric acid, 5 parts of citric acid, 7 parts of ammonium hydrogen difluoride, 3 parts of sodium edetate, 1 part of oxalic acid, 1.5 parts of trichloroethylene, and 0.4 parts of among them, the surfactant is a combination of benzyldimethylstearylammonium chloride (CAS: 122-19-0), hexadecyltrimethylammonium chloride (CAS: 112-02-7), and fatty alcohol polyoxyethylene ether (AEO-9) with a weight ratio of 1.5:1:0.6;
(2) rinsing the degreased aluminum alloy polishing head to be sprayed with deionized water for 4 minutes, then drying at 170° C. for 15 minutes to obtain a pretreated polishing head;
(3) using carborundum for spraying, pure nitrogen gas is used as the plasma gas during the spraying process. The plasma gas flow rate is 5200 L/h, the plasma pressure is 4.5 MPa, the adjustment current is 760 A, the control arc temperature is 4900° C., the powder feeding amount is 0.4 g/min, and the spray gun movement speed is 45 mm/min; after the spraying is completed, surface heat treatment is carried out, with insulation at 500° C. for 17 hours to obtain a sandblasted polishing head; and
(4) using a negative ion dust removal device to remove dust from the surface of the sandblasted polishing head.

In the present disclosure, the main body 1a includes a surface housing 1 and a bottom housing 2, the top of the surface housing 1 and the bottom housing 2 is provided with a detachable mounting head 7, the mounting head 7 is provided with a detachable end cover 11, and a user may replace the mounting head 7 with a nail polisher head, a hair trimmer head, a vacuum cleaner head, a vacuum brush head, a hair dryer head, or a dog brush head according to needs.

In the present disclosure, clamping slots 15 are mounted on both sides of the mounting head 7, clamping buckles 17 are mounted on inner walls of both sides of the end cover 11, and the clamping buckles 17 are adapted to the clamping slots 15.

In the present disclosure, the main body 1a includes a surface housing 1 and a bottom housing 2, the surface housing 1 and the bottom housing 2 are connected, a battery 4 and a motor 5 are mounted between the surface housing 1 and the bottom housing 2, the motor 5 is electrically connected with the battery 4, and the polishing head 6 is fixedly mounted on an output end of the motor 5; and a grinding wheel sleeve 10 is detachably sleeved outside the polishing head 6, and the polishing head 6 and the grinding wheel sleeve 10 are arranged in the end cover 11, the top of the polishing head 6 is provided with a dust collection hood 12, and the user may remove the grinding wheel sleeve 10 and replace it with the dust collection hood 12 according to dust prevention needs.

In the present disclosure, a connecting piece 8 is fixedly mounted at the top of the mounting head 7, a clamping block 9 is mounted on one side of the connecting piece 8, the dust collection hood 12 is clamped on two connecting pieces 8, and an inner wall of the dust collection hood 12 is adapted to the clamping block 9.

In the present disclosure, an anti-skid plate 3 is fixedly mounted on one side, away from the surface housing 1, of the bottom housing 2, preferably on the surface of the surface housing 1 and/or the bottom housing 2.

In the present disclosure, a speed controller 13 that may adjust the motor speed is mounted on the surface of the surface housing 1 and/or the bottom housing 2, and the speed controller 13 is electrically connected with the motor 5, preferably, a knob speed controller 13 is mounted in a center position between the surface housing 1 and the bottom housing 2, the knob speed controller 13 is electrically connected with the motor 5, and one side of the knob speed controller 13 extends to the outside of the surface housing 1.

In the present disclosure, a switch button 14 is mounted on the surface of the surface housing 1 and/or the bottom housing 2, preferably, the switch button 14 is mounted at the bottom between the surface housing 1 and/or the bottom housing 2, and one side of the switch button 14 extends to the outside of the surface housing 1.

In the present disclosure, a side wall of the battery 4 is provided with a PCB motherboard.

### Embodiment II

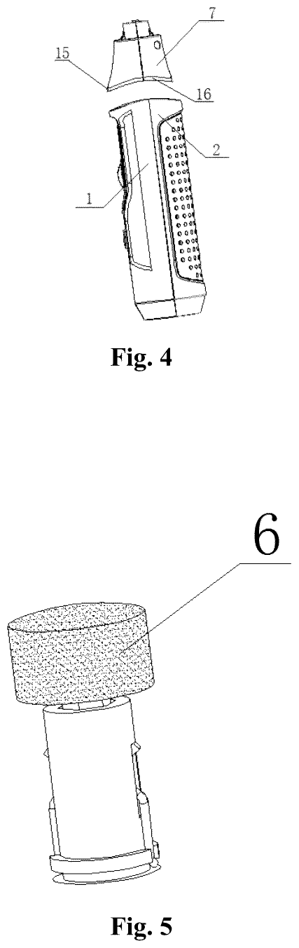

Please refer to FIG. 4, the difference between this embodiment and Embodiment I is that the main body includes a surface housing 1 and a bottom housing 2, and the top of the surface housing 1 and the bottom housing 2 are provided with an integrally formed mounting head 7.

In the present disclosure: during use, the motor 5 is opened by the switch button 14, and the motor 5 drives the polishing head 6 to polish pet nails. Carborundum is sprayed outside the polishing head, to improve the hardness of the polishing head, and increase the service life of the polishing head.

### Embodiment III

The difference between this embodiment and Embodiment I is that the carborundum is replaced with a mixed powder for spraying.

The mixed powder includes the following mass fraction components: 82 parts of carborundum, 4 parts of diamond micro powder, 2 parts of nano alumina, 5 parts of silicon carbide, and 3 parts of boron nitride; among them, diamond micro powder is the model W0.5 diamond micro powder produced by Zhongyuan Superhard Abrasive Tools Co., Ltd. in Zhecheng County; the particle size of the carborundum is 100 mesh size, the particle diameter of nano alumina is 30˜60 nm, with a specific surface area of 10˜20 m²/g (Zhejiang Zhiti Nano Micro New Materials Co., Ltd.), and the average particle diameter of silicon carbide is 800 nm, with an average specific surface area of 20 m²/g (Jinlei Technology); the particle size of boron nitride is 2˜20 μm, with a specific surface area of 6˜25 m²/g (Shandong Jonye Advanced Materials Co., Ltd.).

### Comparative Embodiment I

The difference between this comparative embodiment and Embodiment I is that the degreaser includes the following mass fraction components: 25 parts of 78 wt % sulfuric acid, 10 parts of citric acid, 2 parts of ammonium hydrogen difluoride, 1 part of sodium edetate, 3 parts of oxalic acid, 3 parts of trichloroethylene, and 0.4 parts of surfactant.

### Comparative Embodiment II

The difference between this comparative embodiment and Embodiment I is that the surfactant is a combination of benzyldimethylstearylammonium chloride (CAS: 122-19-0), hexadecyltrimethylammonium chloride (CAS: 112-02-7), and fatty alcohol polyoxyethylene ether (AEO-9) with a weight ratio of 1:1:1.

### Comparative Embodiment III

The difference between this comparative embodiment and Embodiment I is that the surfactant is a combination of fatty alcohol polyoxyethylene ether AEO-3, fatty alcohol polyoxyethylene ether AEO-7, and fatty alcohol polyoxyethylene ether AEO-9 with a weight ratio of 1.5:1:0.6.

### Comparative Embodiment IV

The difference between this comparative embodiment and Embodiment I is that the mixed powder includes the following mass fraction components: 82 parts of carborundum with the particle size D50 of 20 μm, 1 part of diamond micro powder, 5 parts of nano alumina, 1 part of silicon carbide, and 7 parts of boron nitride.

### Comparative Embodiment V

The difference between this comparative embodiment and Embodiment I is that the mixed powder includes the following mass fraction components: 82 parts of carborundum with the particle size D50 of 20 μm, 4 parts of zirconium dioxide (Zhejiang Zhiti Nano Micro New Materials Co., Ltd., VK-R30), 2 parts of nano zinc oxide (Zhejiang Zhiti Nano Micro New Materials Co., Ltd., VK-J200), 5 parts of zirconium diboride (Zhejiang Zhiti Nano Micro New Materials Co., Ltd., JR-B2Zr50), and 3 parts of titanium nitride (Zhejiang Zhiti Nano Micro New Materials Co., Ltd.).

### Comparative Embodiment VI

The difference between this comparative embodiment and Embodiment I is that pure nitrogen gas is used as the plasma gas during the spraying process. The plasma gas flow rate is 4000 L/h, the plasma pressure is 6 MPa, the adjustment current is 850 A, the control arc temperature is 4700° C., the powder feeding amount is 0.6 g/min, and the spray gun movement speed is 30 mm/min; after the spraying is completed, surface heat treatment is carried out, with insulation at 350° C. for 30 hours to obtain a sandblasted polishing head.

### Comparative Embodiment VII

The difference between this comparative embodiment and Embodiment I is that the parameters of the powder are different.

Diamond micro powder is the model W6 diamond micro powder produced by Zhongyuan Superhard Abrasive Tools Co., Ltd. in Zhecheng County.

The particle diameter of nano alumina is 1˜10 μm, with a specific surface area of 5˜10 m²/g (Zhejiang Zhiti Nano Micro New Materials Co., Ltd.).

The average particle diameter of silicon carbide 8 μm, with an average specific surface area of 8 m²/g (Jinlei Technology).

The particle size of boron nitride is 2˜100 μm, with a specific surface area of 2˜35 m²/g (Shandong Jingyi New Materials Co., Ltd.).

### Comparative Embodiment VIII

The difference between this comparative embodiment and Embodiment I is that the particle size of the carborundum is 30 mesh size, the thickness of the carborundum is 0.5 mm, and the uniformity of the thickness is less than or equal to 0.1 mm.

### Comparative Embodiment IX

The difference between this comparative embodiment and Embodiment I is that the particle size of the carborundum is 200 mesh size, the thickness of the carborundum is 0.5 mm, and the uniformity of the thickness is less than or equal to 0.1 mm.

### Performance Test

Performance tests were conducted on the polishing head of Embodiment I and Embodiment III, as well as on the polishing head with attached carborundum in comparative embodiments of I-IX.

1. Hardness: the hardness was determined using a Vickers hardness tester by randomly selecting five different points, measuring the hardness value at each point and calculating the average value.

2. Wear resistance: referring to JB/T7705-1995 loose abrasive grain abrasive wear test method test, using the carborundum spraying aluminum alloy of the present disclosure to prepare samples in accordance with the relevant provisions of 7.3 to test the abrasive grain wear volume.

3. Adhesion level: referring to ASTM D 3359-2017 to determine the adhesion level of the carborundum on the polishing head.

4. Corrosion resistance: spraying the carborundum polishing head with 5% neutral salt spray for 650 hours, and then conducting adhesion level testing.

5. Flatness: observing the surface of the polishing head with the naked eye, the number of surface pinhole is indicated by *, the more *, the more surface pinholes there are.

TABLE 1
Test Results

| | | Abrasive | | | |
|---|---|---|---|---|---|
| | | wear | | | |
| | Hardness | volume | Adhesion | Corrosion | Flat- |
| | (HV) | (m³) | level | resistance | ness |
| Embodiment I | 1984 | 35.76 | 4B | 3B | * |
| Embodiment III | 1998 | 35.52 | 4B | 4B | [symbol] |
| Comparative | 1923 | 36.43 | 3B | 3B | ** |
| Embodiment I | | | | | |
| Comparative | 1934 | 36.25 | 4B | 4B | * |
| Embodiment II | | | | | |
| Comparative | 1943 | 36.15 | 4B | 4B | * |
| Embodiment III | | | | | |
| Comparative | 1853 | 37.48 | 4B | 3B | ** |
| Embodiment IV | | | | | |
| Comparative | 1816 | 38.23 | 4B | 3B | ** |
| Embodiment V | | | | | |
| Comparative | 1914 | 37.22 | 3B | 3B | ** |
| Embodiment VI | | | | | |
| Comparative | 1873 | 37.64 | 3B | 3B | ** |
| Embodiment VII | | | | | |
| Comparative | 1956 | 35.96 | 4B | 3B | * |
| Embodiment VIII | | | | | |
| Comparative | 1949 | 36.08 | 4B | 3B | * |
| Embodiment IX | | | | | |

According to the results, it can be seen that the polishing head of Embodiment I of the present disclosure has high hardness, good wear resistance, high flatness, and high corrosion resistance. By adjusting the spraying conditions to comparative embodiments of I-IX, it can be seen that the comprehensive performance decreases to varying degrees.

The content that is not described in detail in the description belongs to the the prior art well-known to those skilled in the art. Although the embodiments of the present disclosure are already shown and described, it may be understood by those of ordinary skill in the art that a plurality of changes, modifications, replacements, and variations may be made to these embodiments without departing from the principles and spirit of the present disclosure, and the scope of the present disclosure is limited by the appended claims and equivalents thereof.

1. A pet nail polisher, comprising:
a main body, wherein an end portion of the main body being provided with a polishing head; and carborundum being attached outside the polishing head:
wherein the particle size of the carborundum is 60˜150 mesh size, the thickness of the carborundum is 0.4˜0.6 mm, and the uniformity of the thickness is less than or equal to 0.1 mm;
wherein the carborundum being attached outside the polishing head comprises:
(1) immersing the aluminum alloy polishing head to be sprayed completely in a degreaser, and immersing it in a degreaser at 35° C. for 3 minutes. The degreaser includes the following mass fraction components: 36 parts of 75 wt % sulfuric acid, 5 parts of citric acid, 7 parts of ammonium hydrogen difluoride, 3 parts of sodium edetate, 1 part of oxalic acid, 1.5 parts of trichloroethylene, and 0.4 parts of surfactant; among them, the surfactant is a combination of benzyldimethylstearylammonium chloride (CAS: 122-19-0), hexadecyltrimethylammonium chloride (CAS: 112-02-7), and fatty alcohol polyoxyethylene ether (AEO-9) with a weight ratio of 1.5:1:0.6;
(2) rinsing the degreased aluminum alloy polishing head to be sprayed with deionized water for 4 minutes, then drying at 170° C. for 15 minutes to obtain a pretreated polishing head;
(3) using carborundum for spraying, pure nitrogen gas is used as the plasma gas during the spraying process. The plasma gas flow rate is 5200 L/h, the plasma pressure is 4.5 MPa, the adjustment current is 760 A, the control arc temperature is 4900° C., the powder feeding amount is 0.4 g/min, and the spray gun movement speed is 45 mm/min; after the spraying is completed, surface heat treatment is carried out, with insulation at 500° C. for 17 hours to obtain a sandblasted polishing head; and
(4) using a negative ion dust removal device to remove dust from the surface of the sandblasted polishing head.

2. The pet nail polisher according to claim 1, characterized in that: the main body comprises a surface housing and a bottom housing, a detachable mounting head is arranged at a top of the surface housing and the bottom housing, and the detachable mounting head is one of a nail polisher head, a hair trimmer head, a vacuum cleaner head, a vacuum brush head, a hair dryer head, or a dog brush head.

3. The pet nail polisher according to claim 2, characterized in that: a detachable end cover is arranged on the detachable mounting head.

4. The pet nail polisher according to claim 1, characterized in that: the main body comprises a surface housing and a bottom housing, and an integrally formed mounting head is arranged at a top of the surface housing and the bottom housing.

5. The pet nail polisher according to claim 1, characterized in that: the main body comprises a surface housing and a bottom housing, the surface housing and the bottom housing are connected, a battery and a motor are mounted between the surface housing and the bottom housing, the motor is electrically connected with the battery, and the polishing head is fixedly mounted on an output end of the motor.

6. The pet nail polisher according to claim 2, characterized in that: a grinding wheel sleeve is detachably sheathed outside the polishing head, and the polishing head and the grinding wheel sleeve are arranged in an end cover.

7. The pet nail polisher according to claim 6, characterized in that: a dust collection hood is arranged at a top of the polishing head, and the dust collection hood can replace the grinding wheel sleeve.

8. The pet nail polisher according to claim 2, characterized in that: a connecting piece is fixedly mounted at a top of the mounting head, a clamping block is mounted on one side of the connecting piece, the dust collection hood is clamped on the connecting piece, and an inner wall of a dust collection hood is adapted to the clamping block.

9. The pet nail polisher according to claim 2, characterized in that: an anti-skid plate is mounted on a surface of the surface housing and/or the bottom housing.

10. The pet nail polisher according to claim 2, characterized in that: a speed controller is mounted on a surface of the surface housing and/or the bottom housing, the speed controller is electrically connected with a motor, and the speed controller is used to adjust a rotating speed of the motor.

11. The pet nail polisher according to claim 2, characterized in that: a switch button is mounted on a surface of the surface housing and/or the bottom housing, and one side of the switch button extends to an outside of the surface housing and/or the bottom housing.

12. The pet nail polisher according to claim 1, characterized in that: a side wall of a battery is provided with a printed circuit board (PCB) motherboard.

13. The pet nail polisher according to claim 3, characterized in that: clamping slots are mounted on both sides of the mounting head, clamping buckles are mounted on inner walls of both sides of an end cover, and the clamping buckles are adapted to the clamping slots.
